(19) United States
(12) Patent Application Publication
(10) Pub. No.: US 2026/0111738 A1
(43) Pub. Date: Apr. 23, 2026

(54) METHOD AND SYSTEM FOR ORGANIZING NEURAL NETWORK DATA USING TAYLOR SERIES DECOMPOSITION

(71) Applicant: NOLA AI, Inc., New Orleans, LA (US)

(72) Inventor: Correy Allen Kowall, New Orleans, LA (US)

(21) Appl. No.: 19/364,382

(22) Filed: Oct. 21, 2025

Related U.S. Application Data
(60) Provisional application No. 63/709,722, filed on Oct. 21, 2024.

(51) Int. Cl. G06N 3/084; G06N 3/048

(52) U.S. Cl. CPC G06N 3/084; G06N 3/048

(57) ABSTRACT

A system and method for organizing information in neural networks using taylor series decomposition to create predictable, accessible information storage. A system analyzes training data to identify structural relationships including temporal, semantic, hierarchical, and ontological connections between data elements. These relationships are converted into continuous mathematical functions and decomposed using taylor series expansion to generate positioning coefficients that determine optimal spatial coordinates for each data element within the neural network. A composite learning rule trains the network and maintains spatial organization constraints, balancing prediction accuracy with structural integrity. The system generates a position index mapping data element to specific network layers and node ranges, enabling direct information retrieval without full network activation.

### CROSS-REFERENCE TO RELATED APPLICATIONS

This application claims the benefit of, and priority to, U.S. Provisional Application No. 63/709,722 filed on Oct. 21, 2024 the entire specification of which is incorporated herein by reference.

### BACKGROUND OF THE INVENTION

### Field of the Art

The disclosure relates to the field of neural network architecture and training methodologies, and more particularly to the field of systems and methods for organizing and structuring data within neural networks.

### Discussion of the State of the Art

Neural networks and large language models have achieved remarkable capabilities in processing information and generating human-like responses across diverse applications including natural language understanding, computer vision, and predictive analytics. These systems have become integral to modern computing infrastructure, deployed in contexts ranging from consumer applications to mission-critical enterprise systems.

Conventional neural network architectures store information through distributed representations, wherein knowledge is encoded across multiple nodes and layers throughout the network structure. This distributed storage paradigm, while enabling powerful pattern recognition capabilities, creates fundamental challenges regarding information localization. Specific data elements or learned relationships cannot be reliably located within the network structure without complete activation of the entire network. This location unpredictability means that verifying what information the network has stored, or determining where particular knowledge resides, requires exhaustive computational processes that essentially constitute full inference operations.

Further, the distributed nature of information storage with no systematic organization makes accessing information from neural networks complicated. Every query or inference operation, regardless of its complexity or the specificity of information being accessed, necessitates activation and processing through substantially all network layers. This full-network activation requirement results in response latencies typically ranging from hundred to five-hundred milliseconds for modern large language models, along with substantial energy consumption that limits deployment viability on resource-constrained devices.

Existing neural networks primarily focus on architectural modifications such as attention mechanisms, skip connections, and alternative layer designs that increase system complexity without resolving fundamental storage organization issues. Post-training analysis tools, including various visualization and interpretation methods, provide limited insight into network internals but do not address the underlying problem of unpredictable, unorganized information storage.

Therefore, there exists a need in the art for a system and method that can organize neural network data storage during the training process itself, creating predictable and determinable information locations while maintaining the contextual and ontological relationships inherent in the source data.

### SUMMARY OF THE INVENTION

Accordingly, the inventor has conceived and reduced to practice, in a preferred embodiment of the invention, a system and method for organizing information in neural networks using taylor series decomposition to create systematic, relationship-based organization of information within neural network structures. The system comprises a computing platform with one or more processors executing programming instructions to perform training methodology. The system receives training data comprising multiple data elements and analyzes this data to identify structural relationships including temporal relationships that capture chronological ordering and sequences, semantic relationships that reflect conceptual similarity and categorical membership, hierarchical relationships that encode parent-child structures and nested containment, and ontological relationships that define entity types and attribute categories specific to the data domain.

According to a preferred embodiment of the invention, the system generates relationship matrices that quantify the strength and type of connections between data elements. These relationship matrices are converted into continuous mathematical relationship functions suitable for calculus-based analysis. The system applies taylor series expansion to these continuous relationship functions around one or more base points, generating a series expansion comprising multiple terms where each term represents a different level of relationship granularity between data elements.

According to a preferred embodiment of the invention, the system extracts positioning coefficients that serve as spatial organization parameters. The system calculates spatial position coordinates for each data element based on these positioning coefficients. The spatial position coordinates encode the structural relationships through positional proximity such that related information occupies nearby positions while unrelated information is stored at distant positions. The system then maps these abstract spatial position coordinates to concrete neural network architecture specifications including specific layer numbers and node ranges within those layers.

The system initializes the neural network with spatial constraints that bias the network structure according to the calculated spatial position coordinates. These spatial constraints comprise weight initialization biases that favor connections between nodes designated to store related information according to the spatial position coordinates, creating a predisposition within the network structure to organize information according to the relationship-based spatial plan while retaining flexibility to learn and adapt during training.

The system trains the neural network using a novel composite learning rule that simultaneously optimizes multiple objectives. The composite learning rule comprises three components: a first component for minimizing prediction error to ensure the network achieves high accuracy on its primary task, a second component for auto-associative pattern learning that enables the network to reconstruct input patterns and facilitates gradient flow during training, and a third component for maintaining spatial organizational constraints derived from the positioning coefficients to preserve the relationship-based organization throughout the training process. The composite learning rule calculates a composite error as E_total=α·E_accuracy+β·E_spatial+γ·E_association, where α, β, and γ are weighting coefficients that balance the three optimization objectives.

During training, the system continuously monitors organization quality by computing an organization quality score representing the percentage of data elements correctly positioned within acceptable proximity bounds relative to their target spatial positions. The system tracks actual storage positions of data elements by analyzing activation patterns during forward propagation, calculates position error for each data element as the distance between actual storage position and target spatial position, and determines that a data element is correctly positioned when its position error falls below a predetermined threshold.

Responsive to the organization quality score falling below a predetermined quality threshold, indicating that the spatial organization is degrading during training, the system modifies connection weights in the neural network to bias storage of data elements toward their target spatial positions. This modification may include increasing the spatial weight R in the composite error function, decreasing the learning rate to prevent large disruptive weight updates, or applying corrective gradient updates that specifically target organization restoration.

The system repeats the training, adjusting, and monitoring steps iteratively until convergence criteria are satisfied. The convergence criteria includes both prediction accuracy metrics ensuring the network performs well on its primary task and organization quality metrics ensuring the spatial structure is maintained, creating a balanced optimization that achieves both functional performance and structural organization.

Upon completion of training, the system generates a position index that maps each data element to its network location within the trained neural network. The position index comprises multiple entries, where each entry includes a data element identifier, its spatial position coordinate, the corresponding network layer where it is stored, and the corresponding node range within that layer. This position index enables direct access to information without requiring full network activation, transforming the neural network from a black-box system into an accessible knowledge structure.

For information retrieval, the system receives a user query and parses the query to extract entities, intent, attributes, and relationship specifications. Using the position index, the system calculates expected network positions of information relevant to the user query without activating the neural network, performing index lookups and arithmetic position calculations rather than neural network inference. The system performs direct lookup for primary entities in the position index, calculates positions of related information by adding relationship offsets to the primary entity positions (where the relationship offsets correspond to spatial distances between related data elements as determined by the positioning coefficients), and for sequential information, calculates positions by adding sequential offsets to a base position to locate particular items within an ordered sequence.

The system navigates directly to the expected network positions by accessing specific layers and node ranges identified in the position index, bypassing substantially all other network layers and nodes. The system retrieves activation values from these specific layers and node ranges without computing activations for other network portions, typically activating less than one percent of total network nodes for a given query. The system extracts information content by decoding the activation values and generates a response based on the extracted information content.

Unlike conventional neural networks that require activation of substantially all nodes during inference, the present invention materially improves the functioning of the computer itself by introducing a mathematically structured organization of information storage. By using Taylor-series decomposition to derive spatial position coordinates and applying a composite learning rule that maintains positional integrity, the disclosed system reduces the number of active nodes to less than one percent of total network capacity during retrieval operations. This architecture minimizes inference latency and computational energy consumption, enabling faster responses on lower-power hardware and transforming the neural network from a non-deterministic black box into an accessible, indexed information system. These improvements are specific to the underlying computer technology and not merely to the content of the data being processed, thereby enhancing computational efficiency and enabling new classes of hardware-constrained deployments.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention, according to an embodiment of the invention.

FIG. 5 is a neural network training system suitable for implementing the taylor series-based neural network organization methods of the present invention, according to an embodiment of the invention.

FIG. 6 is an exemplary flowchart of a method for training a neural network using the composite learning rule, according to an embodiment of the invention.

FIG. 7 is an exemplary flowchart of a method for efficiently retrieving information from an organized neural network using direct position-based access, according to an embodiment of the invention.

FIG. 8A illustrates the information storage pattern in a conventional neural network trained using standard backpropagation without spatial organization.

FIG. 8B illustrates a structured spatial organization produced by applying the taylor series decomposition methodology of the present invention, according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the inventions(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Taylor series decomposition” is a novel application of taylor series expansion to determine spatial organization of information within neural networks. This process “decomposes” the relationships between data elements into hierarchical spatial offsets (base positions, primary offsets, secondary offsets) that organize the network storage.

“Positioning coefficients” refer to coefficients extracted from taylor series expansion terms that determine spatial distances and offsets between data elements within a neural network. The positioning coefficients include zeroth-order coefficients (base positions for categories), first-order coefficients (primary relationship offsets), and higher-order coefficients (secondary and tertiary relationship offsets), derived from the derivatives in the taylor series expansion f(a), f′(a), f″(a), etc.

“Spatial position coordinates” refer to abstract numerical values representing intended storage locations for data elements within a neural network, calculated based on positioning coefficients and encoding structural relationships through positional proximity. Spatial position coordinates are then mapped to concrete neural network implementation specifications (layer numbers and node ranges). For example, spatial position coordinate 1355 might map to Layer 3, Nodes 580-585.

“Relationship matrices” refer to quantitative data structures that encode the strength and type of connections between pairs of data elements identified during structural relationship analysis.

“Position index” refers to search index that maps data elements to their specific storage locations within the trained neural network, enabling direct navigation to information without full network activation. Each entry in the position index comprises: (i) a data element identifier, (ii) the spatial position coordinate, (iii) the corresponding network layer number, and (iv) the corresponding node range within that layer. The position index transforms the organized neural network into an accessible knowledge structure with determinable information locations.

“Relationship function” refers to a continuous mathematical function that represents the strength and variation of relationships between data elements in a neural network training dataset. For each relationship matrix, the system generates a continuous function ƒ(x) defined over a vector domain of data elements, where ƒ(x) maps structural relationship values to a continuous scalar measure. In one embodiment, ƒ(x) is defined as:

$$f ( x ) = {\sum }_{i , j} {w}_{ij} {R}_{ij} ( x )$$

where R₍ᵢⱼ₎(x) represents normalized relational weights between data elements i and j, and w₍ᵢⱼ₎ are coefficients reflecting temporal, semantic, hierarchical, or ontological connection strength. The function ƒ(x) is differentiable with respect to x, and its derivatives ƒ′(a), ƒ″(a), . . . at one or more base points a are used to obtain the positioning coefficients for Taylor-series expansion. The relationship function thus forms the mathematical bridge between the data's relational structure and the spatial organization of the neural network.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

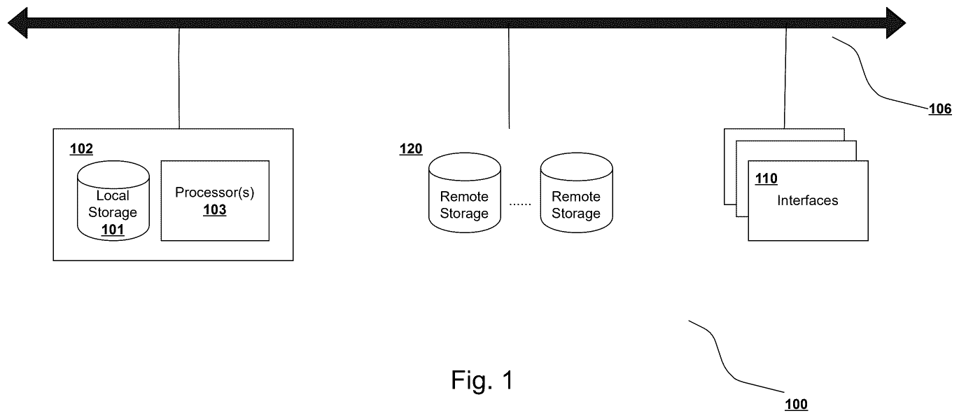

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network, a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control the execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

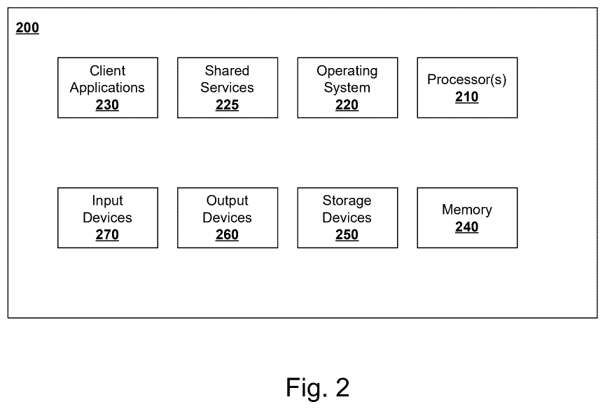

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200 and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example, to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

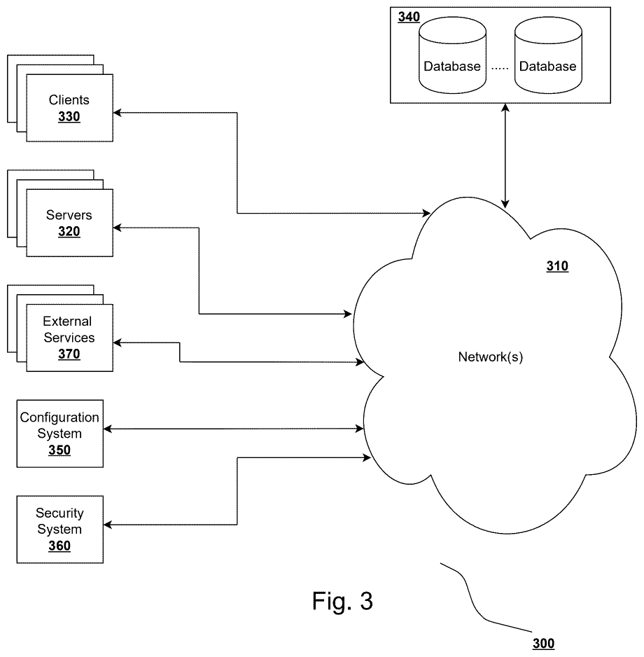

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular incoming communication. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments, one or more databases 340 may comprise a relational database system using a structured query language (SQL), while others may comprise an alternative data storage technology such as those referred to in the art as “NoSQL” (for example, Hadoop Cassandra, Google Big Table, Mongo, and so forth). In some embodiments, variant database architectures such as column-oriented databases, in-memory databases, clustered databases, distributed databases, or even flat file data repositories may be used according to the invention. In addition, Graph-oriented databases, also known as graph databases, are designed to manage and store data structured as graphs, where entities (nodes) are interconnected with relationships (edges), examples include (Amazon Neptune, Microsoft Azure Cosmos DBs, TigerGraph, GraphDB and so forth). These databases are particularly effective for applications involving complex relational queries and traversals, such as social networks, recommendation systems, and network topology analysis.

In addition, vector databases also referred to as vector search databases or similarity search databases, are engineered to index, manage, and retrieve high-dimensional vectors typically generated by machine learning models. These databases are adept at handling operations such as nearest neighbor search in vector space, which is critical for tasks involving image recognition, natural language processing, and recommendation engines, where items are represented as vectors in a multi-dimensional space. Notable examples include Pinecone, Milvus, Weaviate, and Elasticsearch with vector plugins. Vector databases excel in scenarios that require matching patterns or finding similar items based on vector proximity, making them indispensable for modern AI-driven applications such as semantic search, personalization features, and fraud detection systems.

It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each is generally associated with any IT or web systems. It should be understood by one having ordinary skill in the art that any configuration or security subsystems known in the art now or in the future may be used in conjunction with embodiments of the invention without limitation unless a specific security 360 or configuration system 350 or approach is specifically required by the description of any specific embodiment.

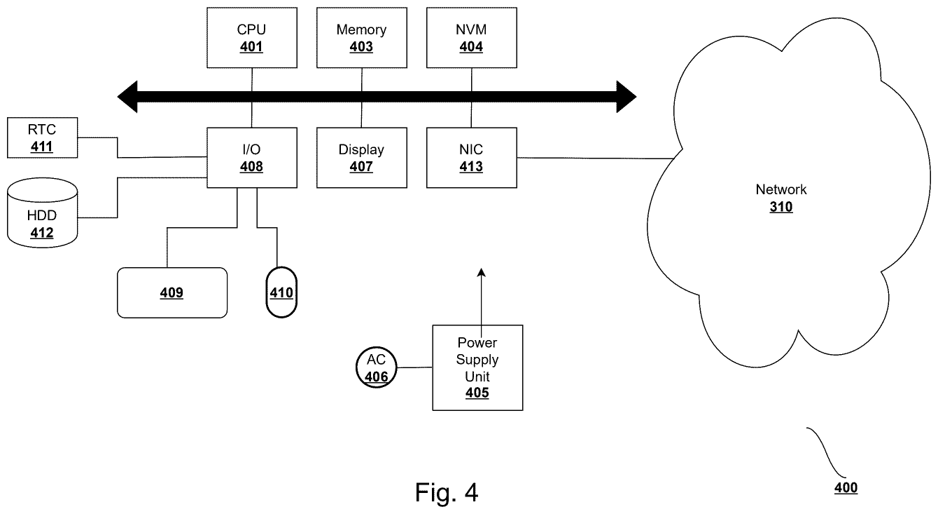

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which may or may not have connections to the Internet. Also shown as part of system 400 is power supply unit 405 connected, in this example, to ac supply 406. Not shown are batteries that could be present, and many other devices and modifications that are well known but do not apply to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

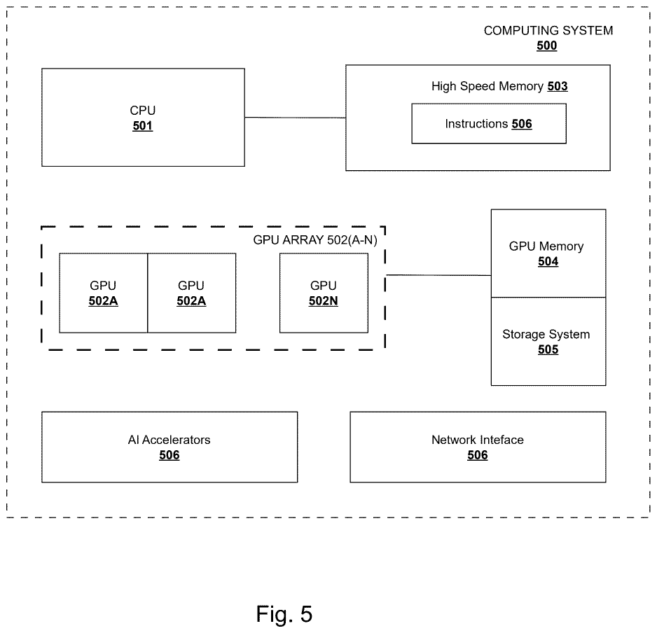

FIG. 5 is a neural network training system suitable for implementing the taylor series-based neural network organization methods of the present invention, according to an embodiment of the invention. In an embodiment, neural network training system includes a high-performance computing system 500 optimized for training large-scale neural networks while maintaining the spatial organization constraints derived from taylor series decomposition.

Central Processing Unit (CPU) 501 may be one or more high-performance processors with a multi-core processor architecture. CPU 501 may orchestrate communication between system components via CPU-Memory Bus. High-Speed Memory 503 is high-bandwidth random access memory configured to store data.

High-speed memory 503 communicates with CPU 501 via CPU-Memory Bus. Graphics Processing Array 502A-N includes one or more graphics processing units (GPUs) or specialized tensor processing units configured to accelerate the parallel computational operations inherent in neural network training. The graphics processing array represents an optional but highly advantageous component that can dramatically accelerate training times. GPU 502A, GPU 502B, through GPU 502N represent individual graphics processing units within the array, where N may range from 1 to 8 or more GPUs in a single system. The GPUs communicate with CPU 501 and each other via memory nus connections, and in advanced configurations may utilize high-speed GPU-to-GPU interconnects to enable efficient multi-GPU training with minimal communication overhead.

GPU memory 504 comprises high-bandwidth memory (HBM) integrated with or closely coupled to the graphics processing units, providing extremely fast access to data required for GPU computations.

Alternative AI Accelerators (TPU/Custom ASIC) 506 represent an alternative or complementary approach to GPU acceleration. AI accelerators 506 provide an alternative path to the GPU array 502A-N. Some implementations may utilize both GPUs and specialized accelerators in a hybrid configuration.

Storage system 505 comprises persistent storage devices configured to store training datasets, trained network models, checkpoints during training, and position indices.

Network Interface 507 provides connectivity to external networks and distributed computing resources, enabling distributed training across multiple machines, access to remote datasets, and deployment of trained models.

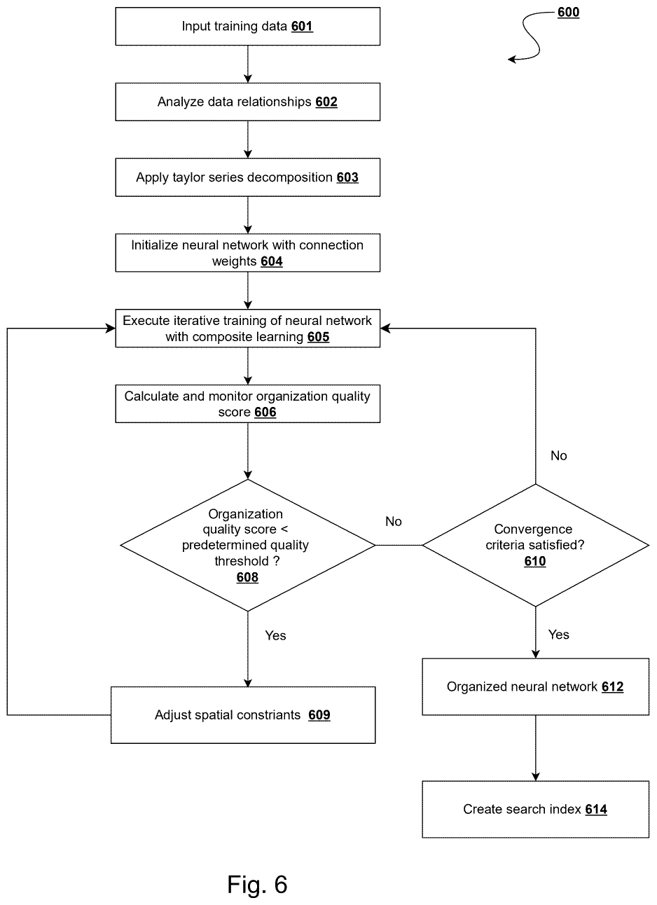

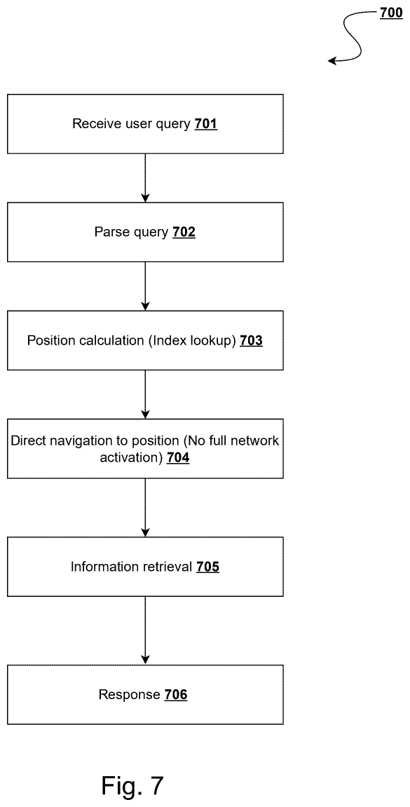

Training instructions 508 comprises the software infrastructure implementing the taylor series-based neural network organization methodology described in this invention. Training instructions 508 implements the taylor series training system detailed in FIG. 6, executing the complete training process illustrated in FIG. 6 including relationship analysis, taylor series decomposition, spatial constraint initialization, and composite learning rule application. Training instructions 508 orchestrates all system components, coordinating CPU operations for taylor series calculations and relationship analysis with GPU operations for neural network training, managing data flow between memory and storage, and ensuring that spatial organization constraints are maintained throughout the training process. Upon completion of training, training instructions 508 generates the organized neural network with its position index, enabling the efficient retrieval operations described in FIG. 7.

High-performance computing system 500 executes training instructions 508 to perform both the training operations of FIG. 6 and the retrieval operations of FIG. 7. During retrieval operations, training instructions 508 receives user queries, calculates expected network positions using the position index without activating the entire neural network, directly navigates to specific layers and node ranges, and extracts information from those positions as detailed in method 700 of FIG. 7. Alternatively, the organized neural network and position index created by system 500 may be deployed to a separate inference system with similar but potentially less powerful hardware specifications, since the retrieval operations of FIG. 7 require significantly less computational resources than the training operations of FIG. 6. The system architecture may be implemented as standalone AI workstation for research and development, a rackmount server in a data center environment, a node within a larger distributed computing cluster, a cloud-based virtual machine with GPU.

### Detailed Description of Exemplary Embodiments

FIG. 6 is an exemplary flowchart of a method 600 for training a neural network using the composite learning rule while maintaining spatial organization derived from taylor series decomposition, according to an embodiment of the invention. The steps of method 600 are performed by computing system 500, specifically by training instructions 508 which orchestrates the CPU 501 for taylor series calculations and the GPU array 502(A-N) for neural network training operations.

At step 601, the training process begins when system 500 receives input training data comprising data elements. The training data represents the knowledge base that the neural network will learn to encode in an organized, spatially structured manner. The training data may include natural language text documents, numerical datasets, time-series information, hierarchical data structures, categorical data, multi-modal information, or any combination thereof. This is the raw information that will be organized and embedded into the neural network through the subsequent training process.

Consider an example, in which the training data comprises a New Orleans Saints football schedule. The training data may include a team entity with associated metadata including entity type, division, and location, along with a schedule structure containing multiple games. Each game record includes structured attributes such as date, time, opponent, and location, demonstrating the hierarchical organization and relationships present in typical training data that will be analyzed and organized by the system.

At step 602, system 500 analyzes the training data to identify structural relationships (also referred to as “contextual relationships”) between the data elements, structural relationships comprise temporal relationships, semantic relationships, hierarchical relationships, and ontological relationships.

In an embodiment, system 500 identifies temporal relationships by detecting chronological sequences, temporal dependencies, and periodic patterns within the training data.

For example, in a schedule dataset like the New Orleans Saints football schedule, the temporal analyzer identifies that games occur in time-sequential order with dates progressing chronologically.

In an embodiment, system 500 may identify semantic relationships by analyzing meaning connections, conceptual similarity, and categorical memberships, determining which concepts are semantically similar and which terms belong to common categories.

In an embodiment, system 500 may identify hierarchical relationships by detecting parent-child structures, tree hierarchies, and nested containment patterns inherent in the data organization.

In an embodiment, system 500 may identify ontological relationships by determining entity types, attribute categories, and relationship types specific to the data domain, categorizing information according to its fundamental nature. After identifying these structural relationships, system 500 generates relationship matrices quantifying the strength and type of connections between the plurality of data elements. These relationship matrices provide a mathematical representation of how data elements relate to one another.

To apply taylor series decomposition, system 500 converts the relationship matrices into continuous mathematical relationship functions suitable for taylor series expansion. These relationship functions represent how relationships vary across the potential storage space of the neural network.

At step 603, system 500 applies taylor series expansion to determine optimal spatial positioning for data elements within the neural network. System 500 may apply taylor series expansion to the relationship functions around one or more base points to generate a series expansion comprising a plurality of terms, where each term represents a different level of relationship between data elements. The taylor series expansion takes the mathematical form

$$f ( x ) \approx f ( a ) + {f}^{′} ( a ) ( x - a ) / 1 ! + {f}^{″} ( a ) {( x - a )}^{2} / 2 ! + higher - order terms .$$

where a is a base point, and each successive derivative term captures increasingly fine-grained relationship distinctions.

Continuing with the example of New Orleans Saints football schedule, taylor series decomposition may be applied to the input training data to determine spatial positions:

$$Base position ( Sports domain ) : f ( a ) = 1000 \\ Primary offset ( Football ) : {f}^{′} ( a ) \times offset = 200 , giving position 1200 \\ Secondary offset ( Specific team ) : {f}^{′} ( a ) \times {offset}^{2} / 2 = 45 , giving position 1245 \\ Schedule structure offset : + 100 , giving position 1345$$

In an embodiment, system 500 extracts positioning coefficients (also called “spatial coefficients” or “taylor coefficients”) from the taylor series expansion terms, wherein each order of the expansion determines a different level of spatial organization. The zeroth-order coefficient f(a) establishes base positions for broad categories of information; for example, f(a)=1000 establishes the base position for the sports domain.

The first-order coefficient f′(a) determines primary relationship offsets based on main categorical distinctions; for example, f′(a) determines the offset of +200 for Football/NFL categorization, yielding position 1200 (base 1000+offset 200).

The second-order coefficient f″(a)/2! determines secondary relationship offsets for specific entities within categories; for example, f″(a)/2! determines the team-specific offset of +45 for the New Orleans Saints entity, resulting in position 1245.

Higher-order coefficients (third-order f′″(a)/3! fourth-order f″″(a)/4! etc.) determine increasingly fine-grained positional distinctions for detailed attributes and relationships.

Additional offsets are calculated for hierarchical data structures such as the schedule structure (+100 offset to position 1345) and sequential data elements such as individual games (uniform +10 offsets yielding positions 1355, 1365, 1375, and 1385), demonstrating how the taylor series expansion mathematical framework systematically translates data relationships into concrete spatial coordinates within the neural network.

In an embodiment, system 500 may calculate spatial position coordinates for each data element based on the positioning coefficients. These spatial position coordinates encode the structural relationships through positional proximity and offsets, meaning that related information will be stored at nearby positions in the network. For the Saints schedule example, system 500 determines that the Saints entity should be at position 1245, the schedule should be offset by 100 positions (at position 1345), and individual games should be spaced 10 positions apart (positions 1355, 1365, 1375, etc.).

In an embodiment, system 500 may map the spatial position coordinates to neural network layer and node ranges, converting abstract position values into concrete network architecture specifications. For instance, position 1355 maps to Layer 3, Nodes 580-585. The mapping of each data element to its target network location and the spatial organization constraints guide network initialization and training.

Node is an individual computational unit within a neural network layer (also called a neuron or unit), which receives weighted inputs, applies an activation function, and produces an output. Node ranges are a contiguous set of nodes within a neural network layer, identified by starting and ending node indices (e.g., Nodes 580-585 refers to nodes numbered 580, 581, 582, 583, 584, and 585). Node ranges serve as concrete storage locations for data elements in the organized neural network.

Based on the offsets computed for New Orleans Saints football schedule, the mapping may be as below:
Position 1245 (Saints entity) maps to Layer 3, Nodes 450-475,
Position 1345 (schedule structure) maps to Layer 3, Nodes 550-575,
   Individual games are mapped to adjacent node ranges:
Position 1355 (Game 1, October 15) maps to Nodes 580-585, and
Position 1365 (Game 2, October 20) maps to Nodes 590-595.

At step 604, system 500 may initialize the neural network with spatial constraints System 500 initializes the neural network with connection weights according to the spatial position coordinates, where the connection weights are biased for storage of related information in nearby positions. First, the abstract position coordinates are mapped to concrete neural network architecture specifications, determining which layer and which nodes within that layer should store each piece of information. For example, position 1245 might map to Layer 3, Nodes 450-475.

Second, connection weights are set with initialization biases that favor connections between nodes storing related information according to the spatial position coordinates. The weight initialization follows the form:

$$W\_initial = W\_random + λ \times Spatial\_Bias ,$$

where spatial_Bias is positive when nodes should store related information and near zero for unrelated information. The parameter X controls the strength of the spatial bias relative to random variation.

In an embodiment, connection weights are numerical parameter associated with a connection between two nodes in a neural network, representing the strength and sign of influence that one node's activation has on another node's activation. Connection weights are adjusted during training through backpropagation or, in this invention, through the composite learning rule.

Further, system 500 initializes a position index ((also referred to as “search index” and interchangeably used in the specification) to track where each data element is currently stored and where it should ideally be stored, enabling continuous monitoring of organization quality throughout training. The initialized network has embedded within its structure a predisposition to store information according to the spatial organization derived from the data's inherent relationships.

The initialized network has embedded within its weight structure a predisposition to store information according to the spatial organization derived from the data's inherent relationships, while retaining the flexibility to learn and adapt during training.

At step 605, system 500 may train the neural network using a composite learning rule. A composite learning rule comprises a first component for minimizing prediction error (E_accuracy), a second component for auto-associative pattern learning (E_association), and a third component for maintaining spatial organizational constraints derived from the positioning coefficients (E_spatial). System 500 calculates a composite error as

$$E\_total = α \cdot E\_accuracy + β \cdot E\_spatial + γ \cdot E\_association ,$$

where E_accuracy measures prediction error between network outputs and target values, E_spatial measures deviation from the target spatial positions, E_association measures auto-associative reconstruction error, and α, β, and γ are weighting coefficients that balance the three objectives.

Typical values are α=0.6, β=0.3, γ=0.1, though these are adjustable based on application requirements. During each training iteration, system 500 performs forward propagation through the network, calculates all three error components, computes composite gradients combining the gradients from all three components, and updates connection weights to minimize the composite error. The combination of multiple error signals provides richer gradient information, enabling faster learning than standard backpropagation alone.

According to an alternative embodiment, system 500 may implement ranked co-factor assignment of individuated taylor series coefficients based on salience ranking. This ranked coefficient assignment creates an adaptive learning curriculum that automatically prioritizes struggling data elements while maintaining established spatial organization for well-learned elements, optimizing training efficiency and reducing overall training cost.

The system calculates error contributions(association/feedback) for each data element, ranks elements from highest-error to lowest-error, and assigns taylor series coefficients inversely proportional to error rank, providing acceleration for high-error elements and dampening for low-error elements.

The weighting coefficients α, β, and γ may be updated (typically by adjusting β upward or downward) to maintain the spatial organization derived from the taylor series decomposition. The composite learning rule provides multiple advantages including accelerated convergence through richer gradient information, mitigation of vanishing gradient problems through the auto-associative component, and balanced optimization between empirical accuracy and theoretical organization ideals. Auto-associative component helps the training by learning to reconstruct its inputs, creating internal representations that capture essential features. In the composite learning rule, auto-associative learning provides additional gradient information and facilitates organization maintenance.

At step 606, system 500 calculates and monitors organization quality score. This monitoring includes comparing an actual position of data elements (determined by analyzing which nodes activate strongly for each element) with their target spatial positions (determined in step 603). Target position is the intended or optimal storage location for a data element within the neural network as determined by taylor series decomposition and spatial position coordinate calculation. The target position represents where the data element should be stored to maintain structural relationships with other data elements.

During training, actual storage positions are compared against target spatial positions to compute organization quality. A data element is considered “correctly positioned” if its position error (distance between actual spatial position and target spatial position is below a predetermined threshold)

In an embodiment, system 500 calculates an organization quality score representing the percentage of data elements correctly positioned within acceptable proximity bounds.

$$Organization\_Score = ( Correctly\_Positioned \_Data \_Elements / Total\_Data Elements ) \times 100 \%$$

In some cases, system 500 may further calculate relationship integrity measuring whether related data elements remain in spatial proximity to each other.

At step 608, system 500 may determine whether the organization quality score falls below a predetermined quality score threshold, then system 500 proceeds to step 608 for corrective action. In some cases, the predetermined quality score threshold may be above eighty five percent and relationship integrity above ninety percent. At step 608, when the organization quality score falls below the predetermined quality threshold, system 500, at step 609 adjusts spatial constraints to restore organization quality. This adjustment implements several corrective mechanisms. System 500 may increase the spatial weight R in the composite error function, giving more emphasis to maintaining organizational structure. System 500 may decrease a learning rate to prevent large weight updates that might disrupt spatial organization, allowing finer adjustments that preserve organization while still improving accuracy. In some cases, system 500 may recalculate target spatial positions based on the current network state, potentially identifying a more achievable organizational structure.

System 500 modifies connection weights in the neural network to bias storage of the plurality of data elements toward their spatial target positions through corrective gradient updates. After applying these adjustments, system 500 may returns to step 605 to continue iterative training with the modified constraints, forming a feedback loop that maintains organization quality throughout the training process.

If organization quality score is above the predetermined quality score threshold, system 500 proceeds to step 610 to evaluate overall training completion. At step 610, system 500 evaluates whether training is completed by checking convergence criteria. The convergence criteria comprise prediction accuracy and organization quality. Training is considered complete only when all conditions are satisfied including accuracy convergence (prediction accuracy reaches target threshold), error stability (composite error change remains minimal across consecutive epochs), organization quality (organization score remains above threshold consistently), relationship preservation (relationship integrity remains high), and gradient magnitude approaching zero. If any condition is not yet satisfied, system 500 proceeds to step 605. System 500 repeats the steps of training, adjusting, and monitoring until convergence criteria are satisfied. System 500 continues training with the next iteration, to execute another training epoch. This creates the main training loop where system 500 repeatedly processes training data, calculates composite errors, updates weights, and monitors organization quality, with potential excursions through adjustment step 609 when organization degrades, until convergence is achieved.

When convergence criteria are satisfied at step 610, the training process terminates and system 500 proceeds to step 612, producing the organized neural network as output. This organized network comprises the trained weight matrices optimized through the composite learning process, the network architecture specification defining the layer structure and connectivity, the embedded spatial organization established through taylor series decomposition and maintained through composite learning, and organization metadata documenting the mapping between concepts and network positions.

At step 614, system 500 may generate a position index to map each data element to its network location within the trained neural network. The position index enables direct access to information without full network activation. System 500 creates index entries for each data element specifying its storage location including the abstract position value, network layer number, specific node indices, and characteristic activation patterns. Activation patterns are the specific configuration of activation values across multiple nodes when a particular input is presented to the neural network. Characteristic activation patterns for data elements are recorded in the position index to facilitate information retrieval.

System 500 may construct a relationship graph structure representing connections between stored information elements with relationship strengths and types. The position index enables information retrieval described in FIG. 7, where system 500 can use the index to navigate directly to relevant network positions rather than requiring full network activation to answer queries. The search index is the critical data structure that enables the efficient retrieval operations of method 700 in FIG. 7.

The method illustrated in FIG. 6 transforms conventional neural network training into an organization-aware learning process executed by computing system 500. The composite learning rule enables simultaneous optimization for both prediction accuracy and spatial organization, while the iterative monitoring and adjustment mechanisms ensure that the spatial structure derived from taylor series decomposition is maintained throughout training. The result is an organized neural network that combines the learning capabilities of deep neural networks with the structured accessibility of traditional knowledge bases, enabling the efficient direct-access retrieval operations described in FIG. 7.

### Temporal Learning Modulation

According to an alternative embodiment, system 500 may implement temporal learning modulation using taylor series coefficients to simulate critical learning periods observed in biological neural development. The fundamental principle underlying this embodiment is that learning efficiency varies systematically over the training timeline, with early training iterations providing greater plasticity for establishing foundational representations, while later iterations benefit from reduced learning rates to prevent disruption of established organizational structure.

System 500 may calculate a temporal positioning coefficient sequence

$$T ( n ) = {T}_{0} + {T}_{1} ( n - {n}_{0} ) + {{T}_{2} ( n - {n}_{0} )}^{2} / 2 !$$

where n represents the training iteration number and n₀ is the reference iteration (typically set to iteration 0 or 1). The temporal coefficients T₀, T₁, T₂ are derived from taylor series expansion of a temporal learning function f(t) that models optimal learning plasticity over time. In a typical implementation, T₀ represents the base temporal coefficient (e.g., T₀=1.0), T₁ represents the first-order decay rate (e.g., T₁=−0.001), and T₂ represents the second-order curvature adjustment (e.g., T₂=0.000001).

The temporal learning function f(t) models the relationship between training time and optimal learning capacity, analogous to critical periods in biological development where young organisms exhibit enhanced learning capability that diminishes with age. For example, in language acquisition, children demonstrate superior phonological learning during early developmental periods compared to adult learners. The temporal learning modulation system applies this principle by implementing higher learning rates during early training iterations (and progressively lower learning rates in later iterations

System 500 may modify the composite learning rule weighting coefficients α, β, γ dynamically according to the temporal positioning coefficients, implementing the formula:

$$α ( n ) = {α}_{0} \times T ( n ) , β ( n ) = {β}_{0} \times T ( n ) , γ ( n ) = {γ}_{0} \times T ( n ) ,$$

where α₀, β₀, γ₀ are the base weights and T(n) provides temporal modulation. This creates adaptive learning behavior where the accuracy term E_accuracy receives stronger emphasis during early training (when α(n) is large), enabling rapid initial learning, while the spatial organization term E_spatial and auto-association term E_association receive progressively more relative importance as training progresses and T(n) decreases.

The temporal modulation mechanism provides several advantages including improved convergence stability by preventing large weight updates late in training that could disrupt established spatial organization, reduced overfitting through automatic learning rate decay, and enhanced final model quality by allowing fine-tuning of spatial relationships during later training phases. The Taylor series formulation ensures smooth, mathematically principled transitions between learning phases rather than abrupt changes that could destabilize training.

### Causal Influence Separation Embodiment

According to an alternate embodiment, system 500 may performs causal relationship decomposition to distinguish direct causal connections from reciprocal feedback effects and spurious correlations within the training data. This capability addresses a fundamental limitation in conventional neural network training where all observed relationships are treated equivalently, regardless of whether they represent true causal influences, mutual feedback effects, or coincidental correlations. The system recognizes that preserving authentic causal structure within the neural network's spatial organization improves both interpretability and predictive accuracy for novel scenarios.

The spatial organization preserves causal hierarchy by assigning causally prior elements to earlier network positions and causally dependent elements to subsequent positions, maintaining consistent directional relationships that reflect true causal flow. For example, in a dataset containing weather patterns and agricultural yields, the system would position temperature and rainfall data at earlier network positions (as causal factors) and crop yield data at later positions (as causal effects), while minimizing the spatial influence of spurious correlations such as coincidental timing relationships.

FIG. 7 is an exemplary flowchart of a method 700 for efficiently retrieving information from an organized neural network using direct position-based access, according to an embodiment of the invention. The steps of method 700 are performed by computing system 500.

At step 701, retrieval process begins when system 500 receives, via an input interface, a user query requesting specific information stored within the organized neural network. Consider an example when the query is something like “When do the Saints play next?” or more complex searches about schedules, dates, or relationships between pieces of information.

At step 702, system 500 parses the user query to extract entities, intent, attributes, and relationship specifications. A query parser may perform analysis comprising multiple operations including but not limited to entity extraction, canonical form conversion, intent classification, attribute identification, temporal context analysis, relationship Identification. Continuing the example discussed in step 701, system 500 parses the query to understand what the user is really asking for. It identifies key entities like “Saints” meaning the New Orleans Saints team, determines what kind of information is needed such as a schedule lookup, understands the time context like looking for future games rather than past ones, and recognizes relationships such as the Saints having a schedule. For example, when someone asks “When do the Saints play next?”, system 500 understands this as a request for the New Orleans Saints entity, needing schedule information, specifically the next upcoming game after today's date.

At step 703, a position calculator calculates expected network positions of information relevant to the user query using the position index without activating the neural network. This calculation uses index lookups and arithmetic operations.

This is where the organizational structure provides efficiency gains. Instead of activating the entire network, system 500 uses the search index to calculate the approximate position where the requested information should be located based on the embedded contextual relationships.

Because the neural network was organized using taylor series decomposition, the position of information is predictable. System 500 can determine that information about a specific date in the Saints schedule should be at a calculable location based on the temporal ordering and semantic relationships.

Continuing the example, system 500 knows the Saints' information is at position 1245 using position index, and their schedule is always stored 100 positions away from the team information, so the schedule starts at position 1345. Individual games are spaced 10 positions apart. To find the next game, system 500 starts at position 1345 where the schedule begins, checks position 1355 which is the first game slot, sees that the date there is Oct. 15, 2025 which is after today, and knows it found the answer. This lookup happens almost instantly because it's just simple addition and checking a few positions with no need to activate millions of network nodes.

At step 704, system 500 navigates directly to expected network positions by accessing specific layers and node ranges identified in the position index, without activating the entire neural network. Rather than propagating input through all network layers from input to output, system 500 directly accesses the specific layers identified during position calculation.

To response to the example query, system 500 may go straight to Layer 3, accesses nodes 580-585. Unlike traditional approach that would activate all one million nodes in neural network, this invention accesses only minimal number nodes, resulting in faster access while using reduced energy.

At step 705, system 500 may read the activation values at those specific positions and decode them back into information. System 500 retrieves activation values from the specific layers and node ranges without computing activations for other network portions, then extracts information content by decoding the activation values. Continuing the example, system 500 finds the date of Oct. 15, 2025 at position 1355, and the time of 8:15 PM EDT. System 500 checks nearby positions where position 1360 has the opponent information showing Tampa Bay Buccaneers, and position 1370 has the location showing Caesars Superdome. System 500 combines these pieces and calculates how confident it is based on the strength of the signals, which in this case is 95% confident.

At step 706, retrieved information is formatted and returned to the user or requesting system. System 500 formats everything into a natural, user-friendly response. For example, the response may be “The New Orleans Saints play next on Wednesday, Oct. 15, 2025 at 8:15 PM EDT against the Tampa Bay Buccaneers at the Caesars Superdome in New Orleans.” Further, system 500 may remember this context, so if the user follows up with “Where?” or “Who's the opponent?” it can instantly jump to positions 1370 or 1360 without starting the search process over again.

There are several advantages to this type or retrieval. Speed is dramatically improved as finding information takes only milliseconds instead of hundreds of milliseconds because system 500 knows exactly where to look. Efficiency is enhanced since only a tiny fraction of the network needs to be accessed for each query. Predictability is ensured because information is organized based on meaningful relationships during training, allowing system 500 to reliably find what it needs without searching randomly through the entire network. Context awareness is built in since the spatial organization means related information is stored nearby, making it easy to gather complete answers and handle follow-up questions seamlessly.

Comparison of Conventional Vs. Organized Neural Networks

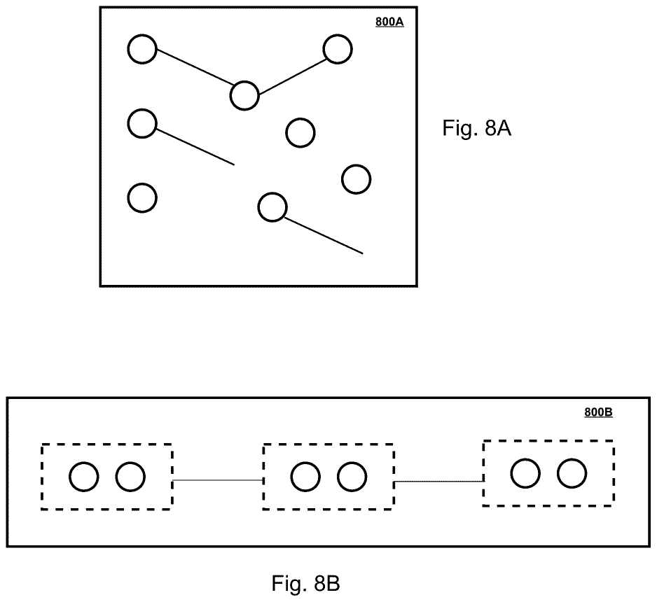

FIG. 8A illustrates the information storage pattern in a conventional neural network 800A trained using standard backpropagation without spatial organization. In conventional neural networks, information about any specific concept is scattered randomly throughout the network with no predictable pattern.

The visualization in FIG. 8A shows nodes represented as circles scattered across multiple layers, connection lines crisscrossing in complex patterns, nodes encoding related concepts are distributed randomly rather than clustered, and arrows indicate that information flow must traverse the entire network from input to output.

Related concepts have no spatial proximity in conventional networks. The team's name, schedule information, and specific dates might be stored in completely different and distant parts of the network. This scattered organization means the network needs dense connectivity between all layers, shown in FIG. 8A by numerous crossing connection lines, because the network must be able to connect any piece of information to any other piece since their locations are unpredictable. Multiple concepts are encoded in overlapping sets of nodes, creating entangled representations where it is impossible to identify where specific information is stored without activating the entire network. This creates the “black box” characteristic of conventional neural networks where even with access to all the weights, it remains extremely difficult to determine what information is stored where or to verify the accuracy without extensive testing.

To answer any query in a conventional network, the entire network must be activated through full forward propagation since relevant information could be anywhere. There is no way to directly access specific information without running the complete network. FIG. 8A visualizes this chaotic organization with nodes scattered across layers, connection lines crisscrossing in complex patterns, and color coding showing that nodes encoding related concepts are distributed randomly rather than grouped together.

FIG. 8B illustrates a structured spatial organization 800B produced by applying the taylor series decomposition methodology of the present invention. In the organized neural network, related information is clustered in nearby locations based on the semantic, structural, and ontological relationships identified during training.

For example, all information about the New Orleans Saints team is clustered in a specific region such as Layer 3, Nodes 450-475, with related concepts stored in adjacent regions. Each piece of information has a predictable, calculable location within the network based on its relationships to other information, determined using taylor series-derived positioning rather than random training dynamics. The same information is consistently stored at the same position across different training sessions.

The organization exhibits hierarchical structure reflecting the relationships in the data. Fundamental concepts and base categories are stored in early layers at lower position numbers, such as positions 500-600 for sports domain concepts and positions 600-700 for temporal concepts. Specific entities like NFL teams are stored at positions 1000-1200, with the New Orleans Saints at position 1245 and the Tampa Bay Buccaneers at nearby position 1250 since they are related teams in the same division. Structured data associated with entities is stored at subsequent positions, with the Saints schedule structure at position 1345. Specific data elements follow in sequence, with individual Saints games stored at positions 1355, 1365, and 1375, using consistent 10-position offsets that preserve the sequential ordering.

The spatial distance between network positions corresponds to the semantic relationship distance in the data. Closely related concepts have nearby positions, moderately related concepts have moderate positional distance, and unrelated concepts are stored in distant regions. This proximity-based organization means the network can use sparser, more targeted connectivity patterns rather than dense all-to-all connections, reducing network complexity. FIG. 8B shows this through more organized, less tangled connection patterns primarily linking nearby nodes.

The organized network resembles a paginated knowledge base where related information occupies coherent regions, similar to chapters in a book. For example, positions 1000-1099 might contain NFL team entities, positions 1100-1199 might contain college football teams, positions 1200-1299 might contain international teams, and positions 1300-1399 might contain team schedules. This predictable organization enables creation of the position index that maps concepts to their network locations, such as mapping “New Orleans Saints” to position 1245 in Layer 3 at nodes 450-475, “Saints Schedule” to position 1345 in Layer 3 at nodes 550-575, and “Game October 15” to position 1355 in Layer 3 at nodes 580-585. With this index, system 500 can directly navigate to specific information without activating the entire network, enabling the efficient retrieval operations described in FIG. 7.

The fundamental difference between FIG. 8A and FIG. 8B is that conventional networks store information unpredictably and require full network activation for any query, while the organized network produced by the present invention stores information in predictable, relationship-based locations and enables direct access to specific information through position-based navigation. This organizational structure is what enables the dramatic efficiency improvements in retrieval speed and computational resource usage demonstrated by the invention.

The skilled person will be aware of a range of possible modifications of the various embodiments described above. Accordingly, the present invention is defined by the claims and their equivalents.

What is claimed is:

1. A system for organizing information in a neural network, the system comprising:
a computer comprising one or more processors, a memory, and a plurality of programming instructions stored in the memory, the plurality of programming instructions when executed by the one or more processors causes the one or more processors to:
receive training data comprising a plurality of data elements;
analyze the training data to identify structural relationships between the plurality of data elements, wherein the structural relationships comprise at least one of: temporal relationships, semantic relationships, hierarchical relationships, or ontological relationships;
responsive to identification of the structural relationships, generate one or more relationship matrices quantifying strength and type of connections between the plurality of data elements;
for each relationship matrix, generate a continuous relationship function ƒ(x) defined over a vector domain representing the plurality of data elements, wherein ƒ(x) maps the quantified relationships to continuous scalar values;
apply taylor-series expansion to each relationship function ƒ(x) around one or more base points to compute positioning coefficients f(a), f′(a), f″(a) and higher-order terms that determine spatial organization within the neural network;
calculate spatial position coordinates for each data element based on the positioning coefficients, wherein the spatial position coordinates encode the structural relationships through positional proximity;
map the spatial position coordinates to neural network layer and node ranges;
initialize the neural network with spatial constraints biased according to spatial position coordinates, wherein the spatial constraints comprise weight initialization biases that favor connections between nodes storing related information according to the spatial position coordinates;
train the neural network by executing a composite learning process implemented by the one or more processors, the composite learning process comprising:
calculating, for each training iteration, a prediction-error term (E_accuracy) representing deviation between network outputs and target values;
calculating a spatial-organization term (E_spatial) representing deviation of actual storage positions of data elements from target spatial positions determined from the positioning coefficients;
calculating an auto-association term (E_association) representing reconstruction error between input and output feature representations;
$$combining the three terms according to a composite objective function E\_total = α \cdot E\_accuracy + β \cdot E\_spatial + γ \cdot E\_association ;$$
updating neural-network connection weights using gradients of E_total computed through a backpropagation or automatic-differentiation algorithm executed by the one or more processors;
compute an organization-quality score by analyzing node-activation patterns generated during forward propagation to determine actual storage positions of data elements;
and
responsive to the organization-quality score falling below the predetermined quality threshold, automatically adjust at least one of: (i) the spatial-weight coefficient R in the composite objective function, or (ii) the learning rate used for weight updates, to restore organization quality during subsequent training iterations;
repeat the steps of training, adjusting and monitoring until convergence criteria are satisfied, wherein the convergence criteria comprise prediction accuracy and the organization quality; and
generate a position index to map each data element to its network location within trained neural network, wherein the position index enables direct access to information.

2. The system of claim 1, wherein to analyze the training data to identify structural relationships between the plurality of data elements, the plurality of programming instructions when executed by the one or more processors causes the one or more processors to:
identify the temporal relationships by detecting chronological sequences, temporal dependencies, and periodic patterns within the training data;
identify semantic relationships by analyzing meaning connections, conceptual similarity, and categorical memberships;
identify hierarchical relationships by detecting parent-child structures, tree hierarchies, and nested containment; and
identify ontological relationships by determining entity types, attribute categories, and relationship types specific to a data domain.

3. The system of claim 1, wherein to train the neural network using a composite learning rule, the plurality of programming instructions when executed by the one or more processors causes the one or more processors to:
calculate a composite error expressed as
$$E\_total = α \cdot E\_accuracy + β \cdot E\_spatial + γ \cdot E\_association ,$$
E_accuracy measures prediction error between network outputs and target values,
E_spatial measures deviation from the target spatial positions
E_association measures auto-associative reconstruction error, and
α, β, and γ are dynamically updated weighting coefficients that are modified during training responsive to changes in an organization-quality score to minimize E_total and maintain the spatial organization derived from the positioning coefficients.

4. The system of claim 1, wherein the plurality of programming instructions when executed by the one or more processors causes the one or more processors to:
assign semantically similar data elements to proximate network positions, wherein semantic distance correlates with positional distance;
assign hierarchically related data elements to nested positional ranges, wherein child elements occupy positions within or adjacent to parent element positions; and
assign temporally or sequentially ordered data elements to positions with consistent linear offsets preserving the ordering.

5. The system of claim 1, wherein to monitor the organization quality during training, the plurality of programming instructions when executed by the one or more processors causes the one or more processors to:
track actual storage positions of data elements by analyzing activation patterns;
calculate a position error for each data element as a distance between an actual storage position and the target spatial position;
responsive to the position error being less than a predetermined threshold, determine that the data element is correctly positioned.

6. The system of claim 1, wherein the position index comprises a plurality of entries, each entry comprising a data element among the plurality of data elements, a spatial position coordinate, a corresponding network layer, and a corresponding node range.

7. The system of claim 1, wherein the positioning coefficients comprises a zeroth-order coefficient extracted from the zeroth-order term f(a) of the taylor series expansion, a first-order coefficient extracted from the first-order term f(a) of the taylor series expansion; and one or more higher-order coefficients extracted from higher-order terms of the taylor series expansion.

8. The system of claim 1, wherein the plurality of programming instructions when executed by the one or more processors causes the one or more processors to:
receive a user query;
parse the user query to extract entities, intent, attributes, and relationship specifications;
calculate expected network positions of information relevant to the user query using the position index without activating the neural network;
navigate directly to expected network positions by accessing specific layers and node ranges identified in the position index;
retrieve activation values from the specific layers and node ranges without computing activations for other network portions;
extract information content by decoding the activation values; and
generate a response based on the extracted information content.

9. The system of claim 6, wherein to calculate expected network positions, the plurality of programming instructions when executed by the one or more processors causes the one or more processors to:
perform direct lookup for primary entities in the position index;
calculate positions of related information by adding relationship offsets to the primary entity positions, wherein the relationship offsets correspond to spatial distances between related data elements as determined by the positioning coefficients; and
for sequential information, calculate positions by adding sequential offsets to a base position to locate particular items within an ordered sequence.

10. The system of claim 1, wherein the one or more processors update the weighting coefficients α, β, and γ dynamically during training responsive to changes in the organization-quality score, thereby maintaining the spatial organization of the neural network while preserving prediction accuracy.

11. A method for organizing information in a neural network, the method comprising:
receiving, at a computer, training data comprising a plurality of data elements;
analyzing the training data to identify structural relationships between the plurality of data elements, wherein the structural relationships comprise at least one of: temporal relationships, semantic relationships, hierarchical relationships, or ontological relationships;
responsive to identification of the structural relationships, generating one or more relationship matrices quantifying strength and type of connections between the plurality of data elements;
for each relationship matrix, generating a continuous relationship function ƒ(x) defined over a vector domain representing the plurality of data elements, wherein ƒ(x) maps the quantified relationships to continuous scalar values;
applying taylor-series expansion to each relationship function ƒ(x) around one or more base points to compute positioning coefficients f(a), f′(a), f″(a) and higher-order terms that determine spatial organization within the neural network;
calculating spatial position coordinates for each data element based on the positioning coefficients, wherein the spatial position coordinates encode the structural relationships through positional proximity;
mapping the spatial position coordinates to neural network layer and node ranges;
initializing the neural network with spatial constraints biased according to spatial position coordinates, wherein the spatial constraints comprise weight initialization biases that favor connections between nodes storing related information according to the spatial position coordinates;
training the neural network by executing a composite learning process implemented by the one or more processors, the composite learning process comprising:
calculating, for each training iteration, a prediction-error term (E_accuracy) representing deviation between network outputs and target values;
calculating a spatial-organization term (E_spatial) representing deviation of actual storage positions of data elements from target spatial positions determined from the positioning coefficients;
calculating an auto-association term (E_association) representing reconstruction error between input and output feature representations;
$$combining the three terms according to a composite objective function E\_total = α \cdot E\_accuracy + β \cdot E\_spatial + γ \cdot E\_association ;$$
and
updating neural-network connection weights using gradients of E_total computed through a backpropagation or automatic-differentiation algorithm executed by the one or more processors;
computing an organization-quality score by analyzing node-activation patterns generated during forward propagation to determine actual storage positions of data elements;
comparing the actual storage positions to target spatial positions determined from the positioning coefficients to calculate a position error for each data element;
determining that a data element is correctly positioned when its position error is less than a predetermined distance threshold; and
responsive to the organization-quality score falling below the predetermined quality threshold, automatically adjusting at least one of: (i) the spatial-weight coefficient 3 in the composite objective function, or (ii) the learning rate used for weight updates, to restore organization quality during subsequent training iterations;
repeating the steps of training, adjusting and monitoring until convergence criteria are satisfied, wherein the convergence criteria comprise prediction accuracy and the organization quality; and
generating a position index to map each data element to its network location within trained neural network, wherein the position index enables direct access to information.

12. The method of claim 11, wherein analyzing the training data to identify structural relationships between the plurality of data elements comprises the steps of:
identifying the temporal relationships by detecting chronological sequences, temporal dependencies, and periodic patterns within the training data;
identifying semantic relationships by analyzing meaning connections, conceptual similarity, and categorical memberships;
identifying hierarchical relationships by detecting parent-child structures, tree hierarchies, and nested containment; and
identifying ontological relationships by determining entity types, attribute categories, and relationship types specific to a data domain.

13. The method of claim 11, wherein training the neural network using a composite learning rule, further comprises the steps of:
calculating a composite error expressed as
$$E\_total = α \cdot E\_accuracy + β \cdot E\_spatial + γ \cdot E\_association ,$$
wherein
E_accuracy measures prediction error between network outputs and target values,
E_spatial measures deviation from the target spatial positions
E_association measures auto-associative reconstruction error, and
α, β, and γ are dynamically updated weighting coefficients that are modified during training responsive to changes in an organization-quality score to minimize E_total and maintain the spatial organization derived from the positioning coefficients.

14. The method of claim 11, wherein the method further comprises:
assigning semantically similar data elements to proximate network positions, wherein semantic distance correlates with positional distance;
assigning hierarchically related data elements to nested positional ranges, wherein child elements occupy positions within or adjacent to parent element positions; and
assigning temporally or sequentially ordered data elements to positions with consistent linear offsets preserving the ordering.

15. The method of claim 11, wherein monitoring the organization quality during training comprises the steps of:
tracking actual storage positions of data elements by analyzing activation patterns;
calculating a position error for each data element as a distance between an actual storage position and the target spatial position;
responsive to the position error being less than a predetermined threshold, determining that the data element is correctly positioned.

16. The method of claim 11, wherein the position index comprises a plurality of entries, each entry comprising a data element among the plurality of data elements, a spatial position coordinate, a corresponding network layer, and a corresponding node range.

17. The method of claim 11, wherein the positioning coefficients comprises a zeroth-order coefficient extracted from the zeroth-order term f(a) of the taylor series expansion, a first-order coefficient extracted from the first-order term f(a) of the taylor series expansion; and one or more higher-order coefficients extracted from higher-order terms of the taylor series expansion.

18. The method of claim 11, wherein the method further comprises:
receiving a user query;
parsing the user query to extract entities, intent, attributes, and relationship specifications;
calculating expected network positions of information relevant to the user query using the position index without activating the neural network;
navigating directly to expected network positions by accessing specific layers and node ranges identified in the position index;
retrieving activation values from the specific layers and node ranges without computing activations for other network portions;
extracting information content by decoding the activation values; and
generating a response based on the extracted information content.

19. The method of claim 16, wherein to calculate expected network positions, the plurality of programming instructions when executed by the one or more processors causes the one or more processors to:
performing direct lookup for primary entities in the position index;
calculating positions of related information by adding relationship offsets to the primary entity positions, wherein the relationship offsets correspond to spatial distances between related data elements as determined by the positioning coefficients; and
for sequential information, calculating positions by adding sequential offsets to a base position to locate particular items within an ordered sequence.

20. The method of claim 1, wherein the method comprises updating the weighting coefficients α, β, and γ dynamically during training responsive to changes in the organization-quality score, thereby maintaining the spatial organization of the neural network while preserving prediction accuracy.
